(19) United States
(12) Patent Application Publication
(10) Pub. No.: US 2024/0205124 A1
(43) Pub. Date: Jun. 20, 2024

(54) PREDICTING PROCESSING UNIT UTILIZATION

(71) Applicant: Adobe Inc., San Jose, CA (US)

(72) Inventors: Lokendra Singh Chauhan, Bangalore (IN); Vikram Sethi, Dublin, CA (US); Bingi Narasimha Karthik, Bengaluru (IN)

(73) Assignee: Adobe Inc., San Jose, CA (US)

(21) Appl. No.: 18/067,951

(22) Filed: Dec. 19, 2022

(51) Int. Cl. H04L 43/0882; H04L 41/16; H04L 43/067

(52) U.S. Cl. CPC H04L 43/0882; H04L 41/16; H04L 43/067

(57) ABSTRACT

In implementations of systems for predicting processing unit utilization, a computing device implements a prediction system to receive timeseries data describing historic processing unit utilization at computing clusters. The historic processing unit utilization at the computing clusters is based on a first network traffic routing protocol. The prediction system generates a predicted processing unit utilization at a computing cluster of the computing clusters during a future period of time using a long short-term memory model based on the timeseries data. A second network traffic routing protocol is determined based on the predicted processing unit utilization. The prediction system replaces the first network traffic routing protocol with the second network traffic routing protocol before the future period of time.

### BACKGROUND

In cloud or multi-cloud environments, balancing of processing unit utilization (e.g., CPU load) among computing clusters included in a group of computing clusters is necessary for the group of computing clusters to operate reliably and efficiently. For instance, over-utilization (e.g., processing unit utilization above a high utilization threshold) of the computing clusters degrades computational performance and increases a risk of a disruption/outage in a cloud-based service. Under-utilization (e.g., processing unit utilization below a low utilization threshold) of the computing clusters is inefficient and increases costs of providing the cloud-based service.

### SUMMARY

Techniques and systems for predicting processing unit utilization are described. In an example, a computing device implements a prediction system to receive timeseries data describing historic processing unit utilization at computing clusters. The historic processing unit utilization at the computing clusters is based on a first network traffic routing protocol such as a default network traffic routing protocol.

The prediction system generates a predicted processing unit utilization at a computing cluster of the computing clusters during a future period of time using a long short-term memory model based on the timeseries data. For example, the predicted processing unit utilization indicates that the computing cluster will be over-utilized or under-utilized during the future period of time. The prediction system determines a second network traffic routing protocol based on the predicted processing unit utilization of the computing cluster. In one example, the prediction system replaces the first network traffic routing protocol with the second network traffic routing protocol before the future period of time.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ digital systems and techniques for predicting processing unit utilization as described herein.

FIG. 2 depicts a system in an example implementation showing operation of a prediction module for predicting processing unit utilization.

FIG. 3 illustrates a representation of timeseries data.

FIG. 4 illustrates a representation of a machine learning model.

FIG. 5 illustrates a representation of training a machine learning model.

FIG. 6 illustrates a representation of predicting processing unit utilization.

FIG. 7 is a flow diagram depicting a procedure in an example implementation in which a first network traffic routing protocol is replaced by a second network traffic routing protocol based on a predicted processing unit utilization at a computing cluster.

FIG. 8 is a flow diagram depicting a procedure in an example implementation in which a predicted processing unit utilization during a future period of time is compared to a utilization threshold and a default network traffic routing protocol is replaced with a generated network traffic routing protocol before the future period of time.

FIG. 9 illustrates a representation of predicting processing unit utilization at computing clusters included in a group of computing clusters.

FIG. 10 illustrates an example system that includes an example computing device that is representative of one or more computing systems and/or devices for implementing the various techniques described herein.

### DETAILED DESCRIPTION

### Overview

In cloud-based environments, balancing of processing unit utilization among computing clusters included in a group of computing clusters is necessary for the group of computing clusters to operate efficiently and reliability. Such balancing is challenging using conventional systems because values of processing unit utilization at the computing clusters change over time and these changes are based on a multitude of different variables (e.g., seasonality, occurrence of particular events, etc.) In order to overcome these challenges, techniques and systems for predicting processing unit utilization are described.

In an example, a computing device implements a prediction system to receive timeseries data describing historic processing unit utilization at computing clusters included in a group of computing clusters. For instance, the historic processing unit utilization is based on a default network traffic routing protocol. In one example, the default network traffic routing protocol routes network traffic between the computing clusters based on moving average values of processing unit utilization at the computing clusters.

The prediction system modifies the timeseries data which initially has a two-dimensional structure (e.g., processing unit utilization, timestamp) to have a three-dimensional structure (e.g., processing unit utilization, day of week, hour of day) for processing using a machine learning model. In an example, the machine learning model is a long short-term memory model, and the prediction system trains the long short-term memory model on a subset of the modified timeseries data (e.g., 70 percent of the modified timeseries data) to predict processing unit utilization at the computing clusters during future periods of time. In this example, the prediction system validates the trained long short-term memory model using a subset of the modified timeseries data that was not used to train the model (e.g., 30 percent of the modified timeseries data).

After validating the trained long short-term memory model, the prediction system implements the trained and validated model to generate a predicted processing unit utilization at a computing cluster of the computing clusters during a future period of time. For example, the prediction system compares the predicted processing unit utilization with utilization thresholds. In a first example, the prediction system determines that the predicted processing unit utilization at the computing cluster is greater than an over-utilized threshold. In the first example, the prediction system determines that the computing cluster is over-utilized during the future period of time. In a second example, the prediction system determines that the predicted processing unit utilization at the computing cluster is less than an under-utilized threshold. In this second example, the prediction system determines that the computing cluster is under-utilized during the future period of time.

The prediction system implements the trained long short-term memory model to generate a predicted processing unit utilization at each computing cluster included in the group of computing clusters during the future period of time. The prediction system uses the predicted processing unit utilizations at the computing clusters to determine whether each of computing clusters is over-utilized or under-utilized during the future period of time. For instance, the prediction system determines a second network traffic routing protocol based on comparisons between the predicted processing unit utilizations and the utilization thresholds.

In an example, the second network traffic routing protocol reduces an amount of network traffic routed to computing clusters that are over-utilized during the future period of time and increases an amount of network traffic routed to computing clusters that are under-utilized during the future period of time. The prediction system replaces the first network traffic routing protocol with the second network traffic routing protocol before the future period of time. In this manner, the prediction system improves efficiency and reliability of operation for the group of computing clusters by decreasing utilization of over-utilized computing clusters and increasing utilization of under-utilized computing clusters. This is not possible using conventional systems that are limited to routing network traffic between computing clusters based on moving average values of processing unit utilization at the computing clusters.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Environment

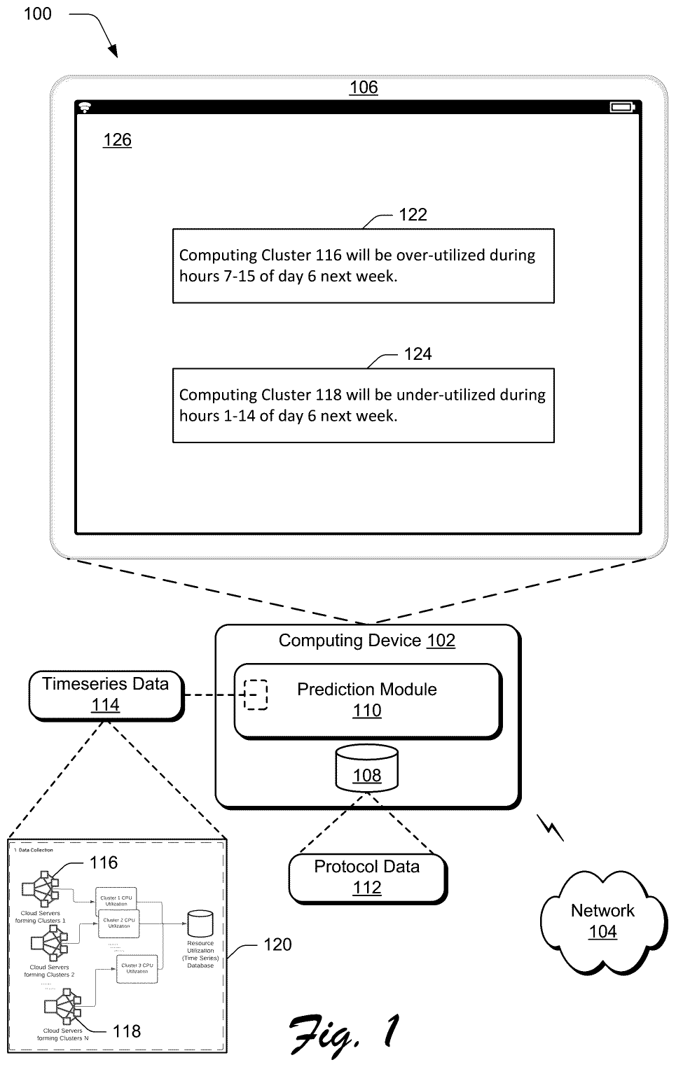

FIG. 1 is an illustration of an environment 100 in an example implementation that is operable to employ digital systems and techniques as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud.”

The illustrated environment 100 also includes a display device 106 that is communicatively coupled to the computing device 102 via a wired or a wireless connection. A variety of device configurations are usable to implement the computing device 102 and/or the display device 106. In an example, the computing device 102 includes a storage device 108 and a prediction module 110. The storage device 108 is illustrated to include protocol data 112 which describes a network traffic routing protocol. For example, the network traffic protocol defines rules and procedures for performing cloud-based tasks requested via the network 104 by available computing clusters of a cloud-based service or multiple cloud-based services.

The prediction module 110 is illustrated as having, receiving, and/or transmitting timeseries data 114. In some examples, the timeseries data 114 describes historic processing unit utilization at computing clusters 116, 118 included in a group 120 of computing clusters. In these examples, the processing units are various central processing units (CPUs), various graphics processing units (GPUs), various accelerators, etc. For instance, the prediction module 110 processes the timeseries data 114 to predict processing unit utilization at the computing clusters 116, 118 during a future period of time.

To do so in one example, the prediction module 110 includes a machine learning model. As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, and/or transfer learning. For example, the machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

In one example, the machine learning model is a long short-term memory model and the prediction module 110 leverages the long short-term memory model to predict processing unit utilization at the computing clusters 116, 118 during the future period of time. In this example, the prediction module 110 trains the long short-term memory model on a subset of the timeseries data 114. Before processing the timeseries data 114 which has a two-dimensional structure (e.g., processor unit usage, timestamp), the prediction module 110 converts this two-dimensional structure into a three-dimensional structure (e.g., processor unit usage, day of week, hour of day). For example, the prediction module 110 uses the converted timeseries data 114 having the three-dimensional structure to train the long short-term memory model to generate predicted processing unit utilization at computing clusters included in the group 120 of computing clusters during future periods of time. When trained, the prediction module 110 is capable of implementing the long short-term memory model to accurately predict processing unit utilization at multiple different ones of the computing clusters 116, 118 during multiple different future periods of time.

Consider an example in which the prediction module 110 implements the trained long short-term memory model to predict processing unit utilization at the computing cluster 116 and processing unit utilization at the computing cluster 118 during the sixth day of the following week. In this example, the prediction module 110 leverages predictions generated by the trained long short-term memory model to generate indications 122, 124 which are displayed in a user interface 126 of the display device 106. As shown, indication 122 states “Computing Cluster 116 will be over-utilized during hours 7-15 of day 6 next week” and indication 124 states “Computing Cluster 118 will be under-utilized during hours 1-14 of day 6 next week.”

For example, the prediction module 110 updates the protocol data 112 by replacing a default network traffic routing protocol described by the protocol data 112 with a network traffic routing protocol generated based on the indications 122, 124. Unlike the default network traffic routing protocol which would likely cause the computing cluster 116 to be over-utilized during hours 7-15 of the sixth day next week, the updated network traffic routing protocol decreases an amount of network traffic routed to the computing cluster 116 by routing this network traffic to other computing clusters included in the group 120 of computing clusters before hour 7 of day 6 next week. In an example, the prediction module 110 generates the updated network traffic routing protocol to cause at least some of the network traffic likely to cause the computing cluster 116 to be over-utilized on the sixth day next week to be routed to the computing cluster 118 which is likely to be under-utilized on day 6 next week. By leveraging the trained machine learning model to predict processing unit utilization during future periods of times at computing clusters included in the group 120 of computing clusters and updating the protocol data 112 based on the predictions, the prediction module 110 reduces a likelihood that the computing cluster 116 will be over-utilized and also reduces a likelihood that the computing cluster 118 on the sixth day next week. This increases operational efficiency of the group 120 of computing clusters such that an amount of excess computational capacity reserved for the group 120 as a “cushion” to prevent a capacity shortage is reducible.

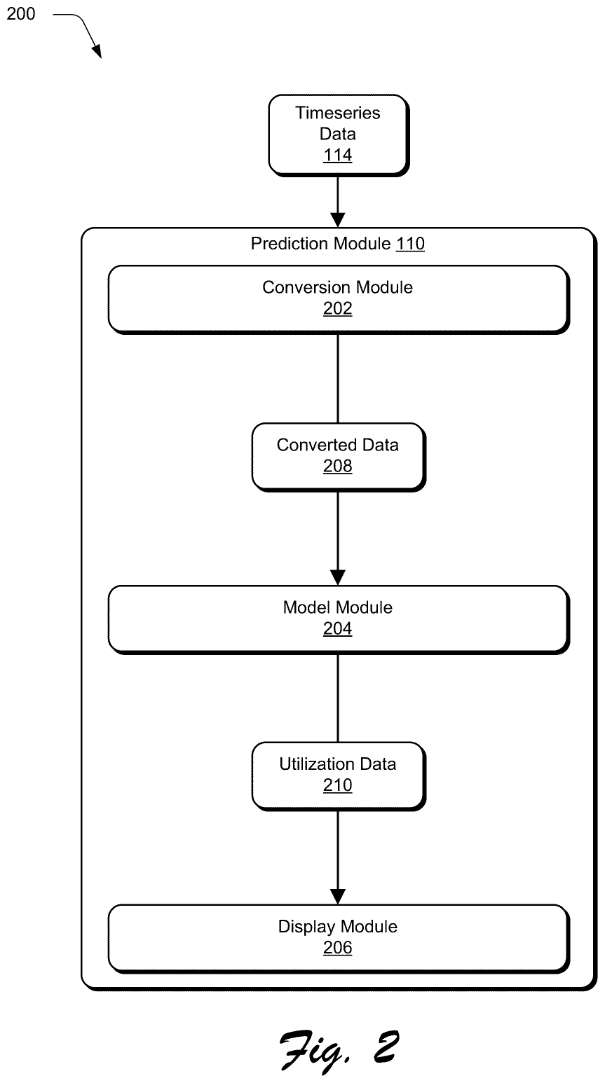

FIG. 2 depicts a system 200 in an example implementation showing operation of a prediction module 110. The prediction module 110 is illustrated to include a conversion module 202, a model module 204, and a display module 206. For example, the prediction module 110 receives the timeseries data 114 describing historic processing unit utilization at computing clusters included in a group of computing clusters such as the group 120. As shown, the conversion module 202 receives and processes the timeseries data 114 to generate converted data 208.

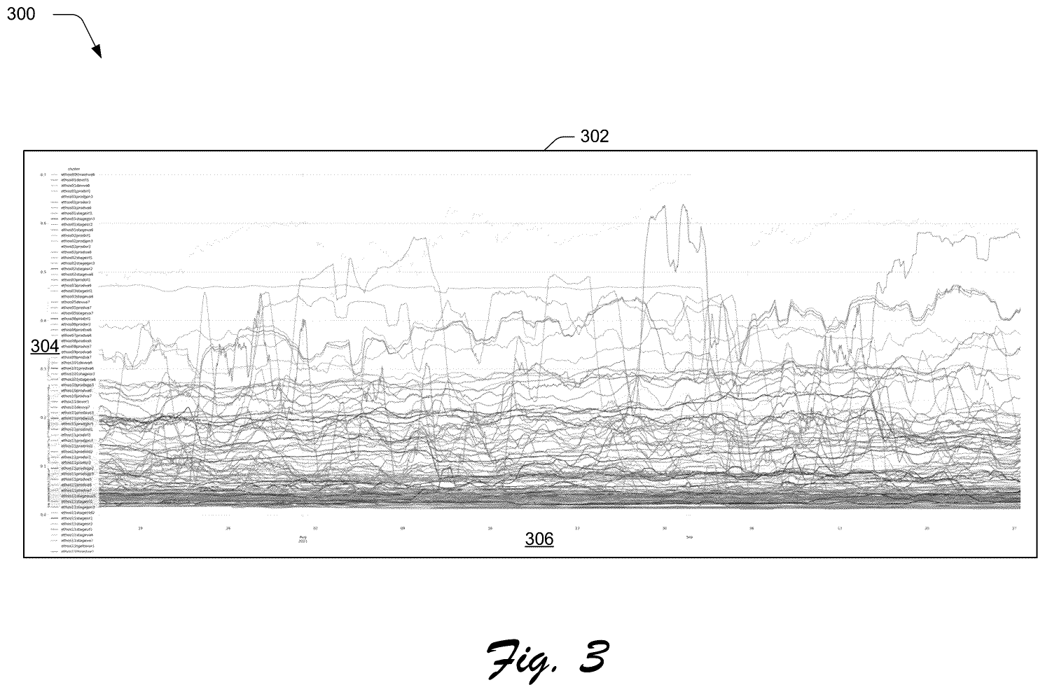

FIG. 3 illustrates a representation 300 of timeseries data. The representation 300 includes indications 302 of historic processing unit utilization at computing clusters 304 during previous periods of time 306. In one example, the timeseries data 114 describes the indications 302. As shown, the indications 302 do not exhibit a time-dependent pattern and the indications 302 include discontinuous observations. For instance, the timeseries data 114 is exogenous and multivariate.

The timeseries data 114 also has a two-dimensional structure (e.g., processor unit usage, timestamp). The conversion module 202 receives and processes the timeseries data 114 to convert its two-dimensional structure into a three-dimensional structure (e.g., processor unit usage, day of week, hour of day). For example, the conversion module 202 generates the converted data 208 as describing the converted timeseries data 114 having the three-dimensional structure. Unlike the timeseries data 114 having the two-dimensional structure, the converted data 208 describes the information included in the timeseries data 114 in the three-dimensional structure which is processable using the machine learning model. In an example, the model module 204 includes the machine learning model.

In some examples, the model module 204 includes an autoregressive integrated moving average model in addition to the machine learning model. In these examples, one autoregressive integrated moving average model is capable of predicting processing unit utilization for one of the computing clusters 304. Also in these examples, in order to process the timeseries data 114 using the autoregressive integrated moving average model, the conversion module 202 fills in the discontinuous observations of the indications 302 as part of generating the converted data 208.

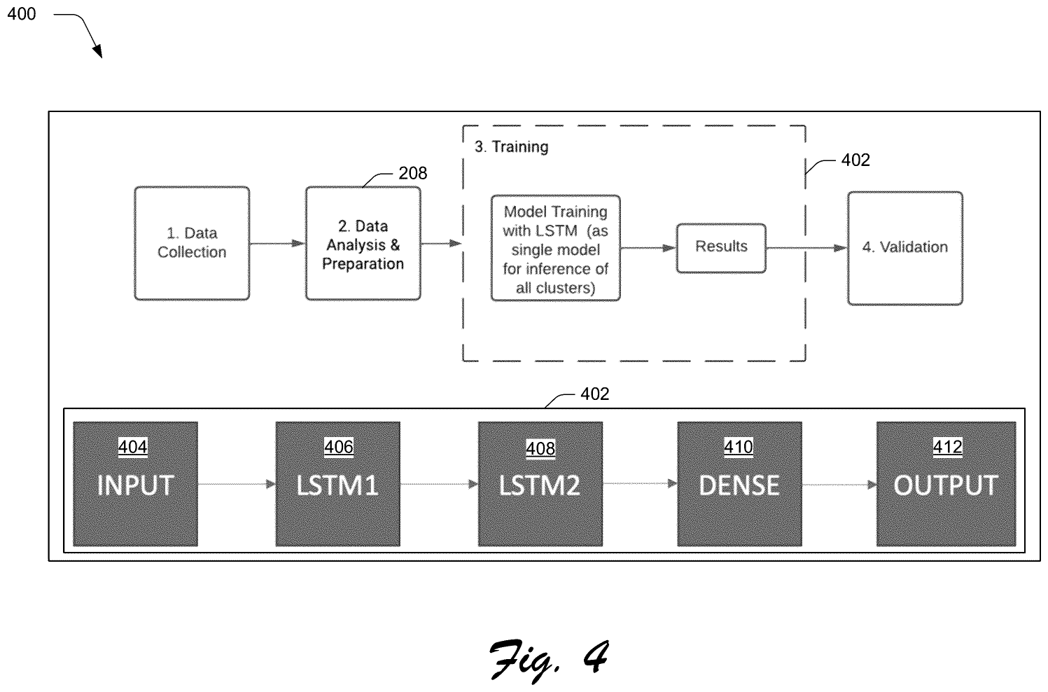

FIG. 4 illustrates a representation 400 of a machine learning model. For instance, the model module 204 receives and processes the converted data 208 using the machine learning model which includes a long short-term memory model 402 to generate utilization data 210. The long short-term memory model 402 is a type of recurrent neural network that is capable of learning order dependence, and the model 402 includes stacked layers (e.g., a layer prior to each subsequent layer returns a sequence). In some examples, the long short-term memory model 402 includes units that include a cell, an input gate, an output gate, and a forget gate. Flow of information into and out from the cell is controlled by the three gates, and the cell remembers values over arbitrary time intervals.

In the illustrated example, the long short-term memory model 402 receives an input 404 (e.g., the converted data 208) to be processed by a first layer 406. For example, the first layer 406 includes 64 memory cells with a rectified linear unit (ReLU) activation function. A second layer 408 receives a sequence from the first layer 406. In an example, the second layer 408 includes 32 memory cells with an ReLU activation function. In this example, dense layers 410 receive a sequence from the second layer 408 to generate an output 412.

In one example, the dense layers 410 include five dense layers. In other examples, the dense layers 410 include 10 dense layers, 20 dense layers, and so forth. Once trained, the long short-term memory model 402 receives and processes the converted data 208 to generate the output 412. For example, the model module 204 generates the utilization data 210 as describing the output 412.

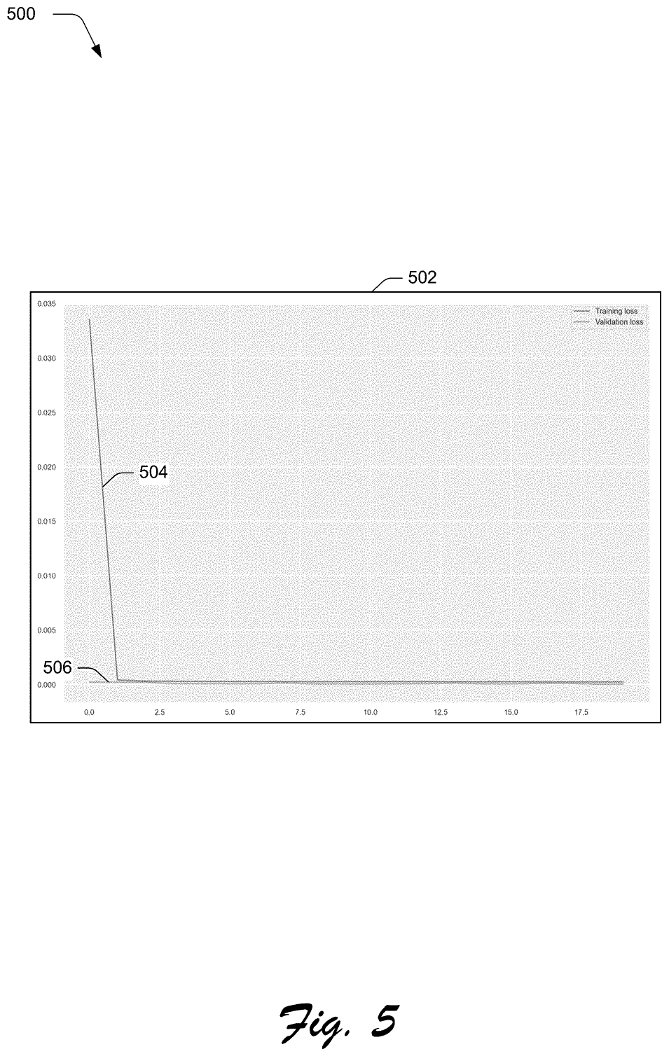

FIG. 5 illustrates a representation 500 of training a machine learning model. The representation 500 includes a chart 502 that illustrates training loss 504 and validation loss 506 while the model module 204 trains and validates the long short-term memory model 402, respectively. In one example, the model module 204 trains the long short-term memory model 402 using an Adam optimizer and dropout of 0.2. In this example, the model module 204 trains the long short-term memory model 402 using 70 percent of the converted data 208, and the model module 204 validates the trained long short-term memory model 402 using 30 percent of the converted data 208 that was not used for training. After training the long short-term memory model 402, the model module 204 generates the utilization data 210 as describing the output 412.

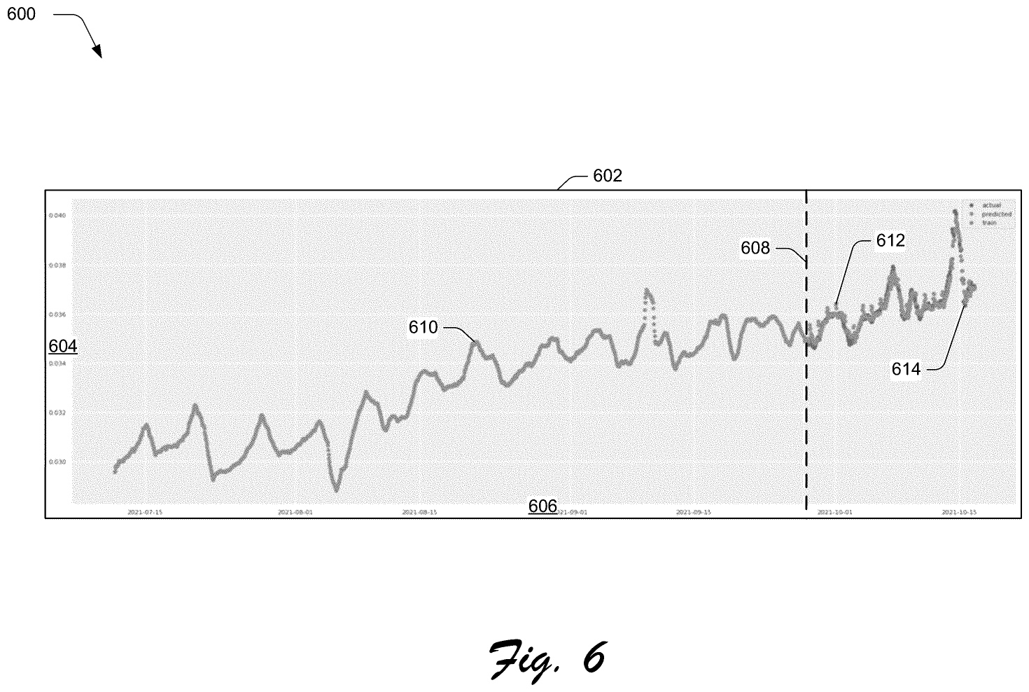

FIG. 6 illustrates a representation 600 of predicting processing unit utilization. The display module 206 receives and processes the utilization data 210 to generate a summary 602 of historic and predicted processing unit utilization at a computing cluster of the computing clusters 304. In an example, the display module 206 generates the summary 602 for display in the user interface 126 of the display device 106. As shown, the summary 602 presents values of processing unit utilization 604 at different periods of time 606.

A temporal indication 608 separates values 610 of historic processing unit utilization at the computing cluster of the computing clusters 304 used to train the long short-term memory model 402 (e.g., described by the converted data 208) from values 612 of predicted processing unit utilization at the computing cluster generated by the trained long short-term memory model 402. Values 614 of observed processing unit utilization at the computing cluster of the computing clusters 304 are included in the summary 602 on a right side of the temporal indication 608 along with the values 612 of predicted processing unit utilization. Differences between ones of the values 612 and corresponding ones of the values 614 are relatively small which indicates that the trained long short-term memory model 402 is capable of accurately predicating processing unit utilization at the computing cluster of the computing clusters 304.

For example, the trained long short-term memory model 402 is capable of generating all of the values 612 without retraining the long short-term memory model 402. This is not possible in conventional systems which require retraining of a model after each prediction generated by the model. In another example, the trained long short-term memory model 402 is capable of generating predicted processing utilization at every computing cluster included in the computing clusters 304 which is also not possible using conventional systems that are limited to training one model for each computing cluster included in the computing clusters 304.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

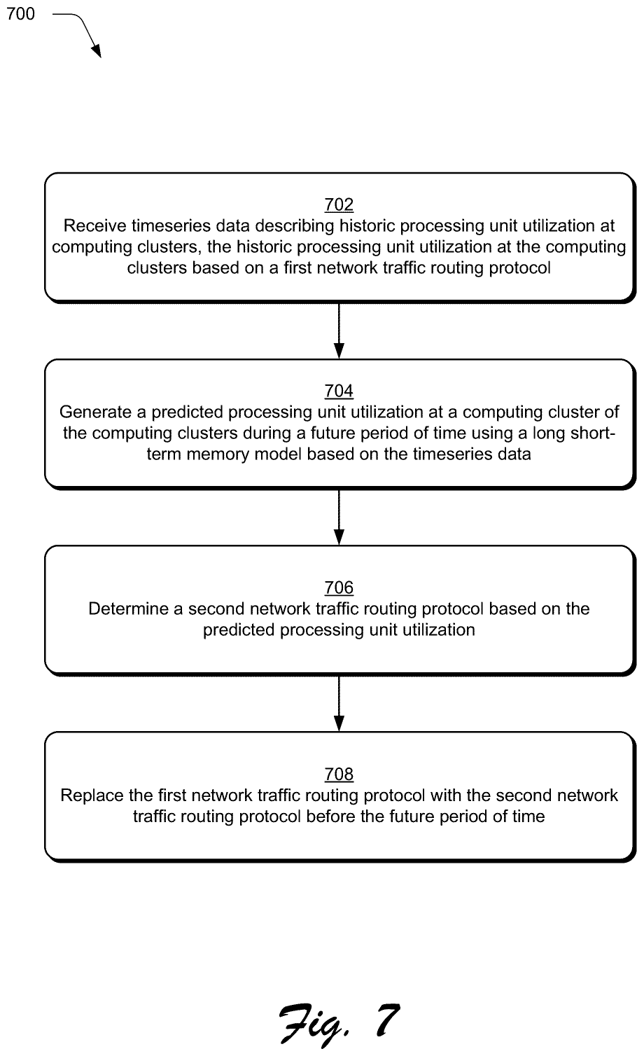

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-6. FIG. 7 is a flow diagram depicting a procedure 700 in an example implementation in which a first network traffic routing protocol is replaced by a second network traffic routing protocol based on a predicted processing unit utilization at a computing cluster.

Timeseries data is received describing historic processing unit utilization at computing clusters, the historic processing unit utilization at the computing clusters is based on a first network traffic routing protocol (block 702). In some examples, the computing device 102 implements the prediction module 110 to receive the timeseries data. A predicted processing unit utilization at a computing cluster of the computing clusters during a future period of time is generated using a long short-term memory model based on the timeseries data (block 704). For example, the prediction module 110 generates the predicted processing unit utilization at the computing cluster.

A second network traffic routing protocol is determined based on the predicted processing unit utilization (block 706). In one example, the computing device 102 implements the prediction module 110 to determine the second network traffic routing protocol. The first network traffic routing protocol is replaced with the second network traffic routing protocol before the future period of time (block 708). For example, the prediction module 110 replaces the first network traffic routing protocol with the second network traffic routing protocol.

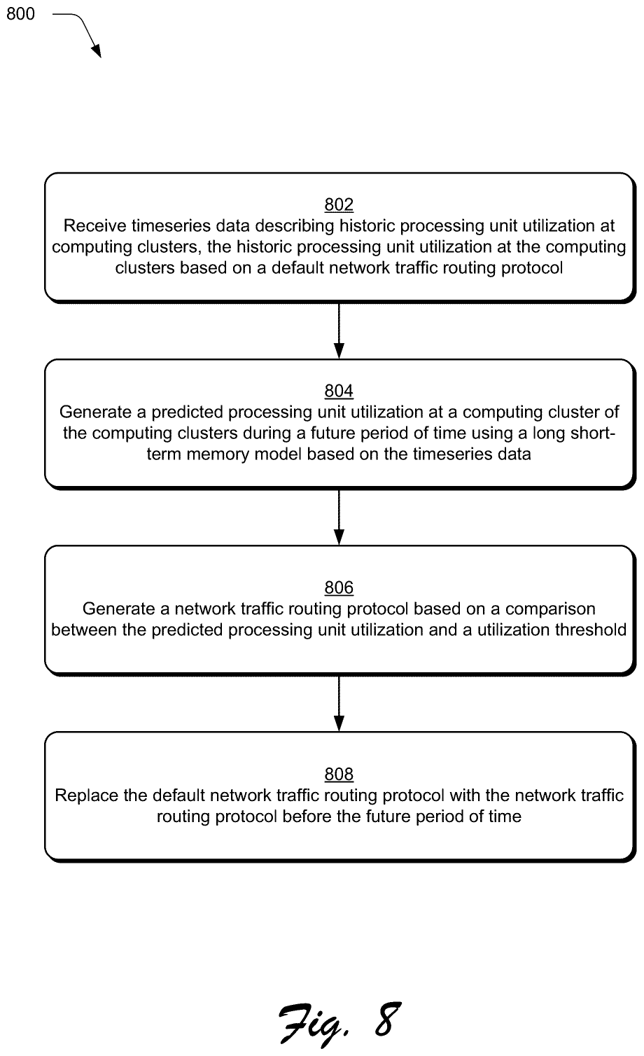

FIG. 8 is a flow diagram depicting a procedure 800 in an example implementation in which a predicted processing unit utilization during a future period of time is compared to a utilization threshold and a default network traffic routing protocol is replaced with a generated network traffic routing protocol before the future period of time. Timeseries data is received describing historic processing unit utilization at computing clusters, the historic processing unit utilization at the computing clusters is based on a default network traffic routing protocol (block 802). In an example, the prediction module 110 receives the timeseries data. A predicted processing unit utilization at a computing cluster of the computing clusters during a future period of time is generated using a long short-term memory model based on the timeseries data (block 804). For example, the computing device 102 implements the prediction module 110 to generate the predicted processing unit utilization at the computing cluster.

A network traffic routing protocol is generated based on a comparison between the predicted processing unit utilization and a utilization threshold (block 806). In some examples, the prediction model 110 generates the network traffic routing protocol. The default network traffic routing protocol is replaced with the network traffic routing protocol before the future period of time (block 808). In one example, the computing device 102 implements the prediction module 110 to replace the default network traffic routing protocol with the network traffic routing protocol.

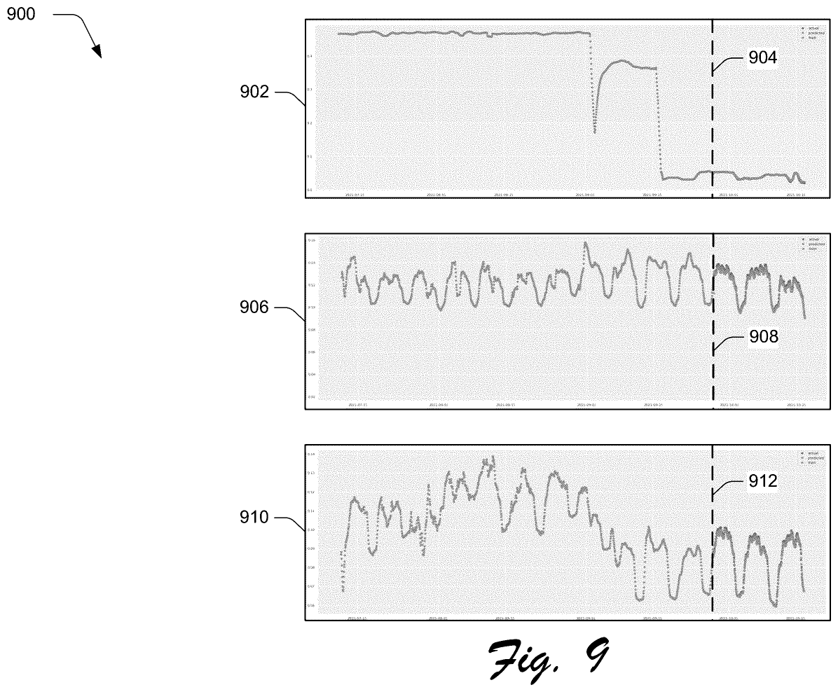

FIG. 9 illustrates a representation 900 of predicting processing unit utilization at computing clusters included in a group of computing clusters. The representation 900 includes a first summary 902 for a first computing cluster included in a group of computing clusters. For instance, the first summary 902 includes a temporal indication 904 that separates values of processing unit utilization at the first computing cluster used to train the long short-term memory model 402 (left of the temporal indication 904) from values of predicted processing unit utilization at the first computing cluster generated by the trained long short-term memory model 402 (right of the temporal indication 904).

The representation 900 also includes a second summary 906 for a second computing cluster included in the group of computing clusters. As shown, the second summary 906 includes a temporal indication 908 which separates values of processing unit utilization at the second computing cluster used to train the long short-term memory model 402 (left of the temporal indication 908) from values of predicted processing unit utilization at the second computing cluster generated by the trained long short-term memory model 402 (right of the temporal indication 908). Similarly, a third summary 910 for a third computing cluster included in the group of computing clusters includes a temporal indication 912 that separates values of processing unit utilization at the third computing cluster used to train the long short-term memory model 402 (left of the temporal indication 912) from values of predicted processing unit utilization at the third computing cluster generated by the trained long short-term memory model 402 (right of the temporal indication 912).

Consider an example in which the prediction module 110 compares the values of predicted processing unit utilization at the first computing cluster generated by the trained long short-term memory model 402 (right of the temporal indication 904) to a utilization threshold. In this example, the values of predicted processing unit utilization at the first computing cluster are not greater than an over-utilized threshold. Accordingly, the first computing cluster is not over-utilized during a future period of time. Continuing this example, the values of predicted processing unit utilization at the first computing cluster are less than an under-utilized threshold. Because of this, the first computing cluster is under-utilized during the future period of time.

For example, the values of predicted processing unit utilization at the second computing cluster are not less than the under-utilized threshold. In this example, the second computing cluster is not under-utilized during the future period of time. However, the values of predicted processing unit utilization at the second computing cluster are greater than the over-utilized threshold. Thus, the prediction module 110 determines that the second computing cluster is over-utilized during the future period of time.

The values of predicted processing unit utilization at the third computing cluster are not less than the under-utilized threshold. Similarly, the values of predicted processing unit utilization at the third computing cluster are not greater than the over-utilized threshold. Accordingly, the third computing cluster is not under-utilized or over-utilized during the future period of time.

Consider another example in which the prediction module 110 determines that the first computing cluster is under-utilized during the future period of time and the second computing cluster is over-utilized during the future period of time. In this example, the values of predicted processing unit utilization at the first computing cluster and the values of predicted processing unit utilization at the first computing cluster are based on a default network traffic routing protocol. The prediction module 110 generates a network traffic routing protocol which increases an amount of network traffic routed to the first computing cluster during the future period of time and decreases an amount of network traffic routed to the second computing cluster during the future period of time. For example, the prediction module 110 replaces the default network traffic routing protocol with the generated network traffic routing protocol before the future period of time (right of the temporal indications 904, 908). In this way, the prediction module 110 reduces a risk of the first computing cluster being under-utilized during the future period of time as well as reduces a risk of the second computing cluster being over-utilized during the future period of time.

### Example System and Device

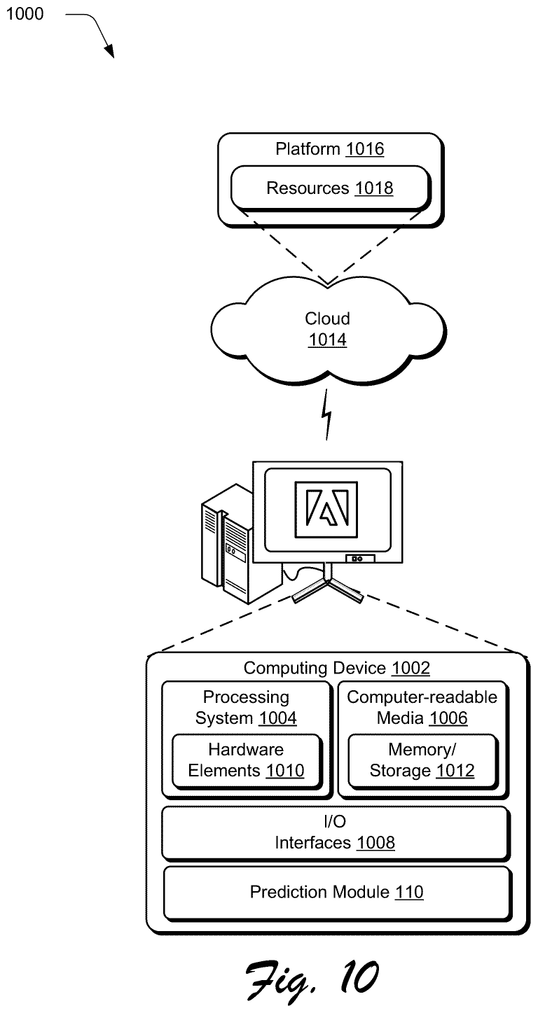

FIG. 10 illustrates an example system 1000 that includes an example computing device that is representative of one or more computing systems and/or devices that are usable to implement the various techniques described herein. This is illustrated through inclusion of the prediction module 110. The computing device 1002 includes, for example, a server of a service provider, a device associated with a client (e.g., a client device), an on-chip system, one or more Internet of Things (IoT) devices, and/or any other suitable computing device or computing system.

The example computing device 1002 as illustrated includes a processing system 1004, one or more computer-readable media 1006, and one or more I/O interfaces 1008 that are communicatively coupled, one to another. Although not shown, the computing device 1002 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware elements 1010 that are configured as processors, functional blocks, and so forth. This includes example implementations in hardware as an application specific integrated circuit or other logic device formed using one or more semiconductors. The hardware elements 1010 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1006 is illustrated as including memory/storage 1012. The memory/storage 1012 represents memory/storage capacity associated with one or more computer-readable media. In one example, the memory/storage 1012 includes volatile media (such as random access memory (RAM)) and/or nonvolatile media (such as read only memory (ROM), Flash memory, optical disks, magnetic disks, and so forth). In another example, the memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 1010. For example, the computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices 1002 and/or processing systems 1004) to implement techniques, modules, and examples described herein.

The techniques described herein are supportable by various configurations of the computing device 1002 and are not limited to the specific examples of the techniques described herein. This functionality is also implementable entirely or partially through use of a distributed system, such as over a “cloud” 1014 as described below.

The cloud 1014 includes and/or is representative of a platform 1016 for resources 1018. The platform 1016 abstracts underlying functionality of hardware (e.g., servers) and software resources of the cloud 1014. For example, the resources 1018 include applications and/or data that are utilized while computer processing is executed on servers that are remote from the computing device 1002. In some examples, the resources 1018 also include services provided over the Internet and/or through a subscriber network, such as a cellular or Wi-Fi network.

The platform 1016 abstracts the resources 1018 and functions to connect the computing device 1002 with other computing devices. In some examples, the platform 1016 also serves to abstract scaling of resources to provide a corresponding level of scale to encountered demand for the resources that are implemented via the platform. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

1. A method comprising:
receiving, by a processing device, timeseries data describing historic processing unit utilization at computing clusters, the historic processing unit utilization at the computing clusters based on a first network traffic routing protocol;
generating, by the processing device, a predicted processing unit utilization at a computing cluster of the computing clusters during a future period of time using a long short-term memory model based on the timeseries data;
generating an additional predicted processing unit utilization at an additional computing cluster of the computing clusters during a period of time that is before or after the future period of time without retraining the long short-term memory model;
determining, by the processing device, a second network traffic routing protocol based on the predicted processing unit utilization; and
replacing, by the processing device, the first network traffic routing protocol with the second network traffic routing protocol before the future period of time.

2. The method as described in claim 1, further comprising generating converted timeseries data that is three-dimensional from the timeseries data wherein the predicted processing unit utilization is generated based on the converted timeseries data.

3. The method as described in claim 1, wherein the predicted processing unit utilization at the computing cluster is greater than an over-utilized threshold and the second network traffic routing protocol decreases an amount of network traffic routed to the computing cluster before the future period of time.

4. The method as described in claim 1, wherein the predicted processing unit utilization at the computing cluster is less than an under-utilized threshold and the second network traffic routing protocol increases an amount of network traffic routed to the computing cluster before the future period of time.

5. The method as described in claim 1, wherein the long short-term memory model includes five dense layers.

6. The method as described in claim 1, wherein the long short-term memory model is trained on a subset of the timeseries data to predict processing unit utilization at the computing clusters.

7. The method as described in claim 6, wherein the generating the additional predicted processing unit utilization at the additional computing cluster of the computing clusters during the period of time is before the future period of time and the second network traffic routing protocol is determined based also on the additional predicted processing unit utilization.

8. The method as described in claim 6, wherein the generating the additional predicted processing unit utilization at the additional computing cluster of the computing clusters during the period of time that is after the future period of time and the second network traffic routing protocol is determined based also on the additional predicted processing unit utilization.

9. The method as described in claim 1, wherein the second network traffic routing protocol is determined based also on the additional predicted processing unit utilization.

10. The method as described in claim 1, wherein the second network traffic routing protocol is determined based on a predicted processing unit utilization at each computing cluster of the computing clusters during the future period of time.

11. A system comprising:
a memory component; and
a processing device coupled to the memory component, the processing device to perform operations comprising:
receiving timeseries data describing historic processing unit utilization at computing clusters, the historic processing unit utilization at the computing clusters based on a default network traffic routing protocol;
generating a predicted processing unit utilization at a computing cluster of the computing clusters during a future period of time using a long short-term memory model based on the timeseries data;
generating an additional predicted processing unit utilization at an additional computing cluster of the computing clusters during a period of time that differs from the future period of time without retraining the long short-term memory model;
generating a network traffic routing protocol based on the predicted processing unit utilization and a utilization threshold; and
replacing the default network traffic routing protocol with the network traffic routing protocol before the future period of time.

12. The system as described in claim 11, wherein the utilization threshold is at least one of an under-utilized threshold or an over-utilized threshold.

13. The system as described in claim 11, wherein the additional predicted processing unit utilization is generated using an autoregressive integrated moving average model based on the timeseries data.

14. The system as described in claim 11, wherein the network traffic routing protocol is generated based on a predicted processing unit utilization at each computing cluster of the computing clusters during the future period of time.

15. The system as described in claim 11, wherein the long short-term memory model is trained on a subset of the timeseries data to predict processing unit utilization at the computing clusters.

16. The system as described in claim 15, wherein the generating the network traffic protocol is further based on the additional predicted processing unit utilization.

17. A non-transitory computer-readable storage medium storing executable instructions, which when executed by a processing device, cause the processing device to perform operations comprising:
receiving timeseries data describing historic processing unit utilization at computing clusters, the historic processing unit utilization at the computing clusters based on a first network traffic routing protocol;
generating a predicted processing unit utilization at a computing cluster of the computing clusters during a future period of time using a long short-term memory model based on the timeseries data;
generating an additional predicted processing unit utilization at an additional computing cluster of the computing clusters during a period of time that is before or after the future period of time without retraining the long short-term memory model;
determining a second network traffic routing protocol based on the predicted processing unit utilization and the additional predict processing unit utilization; and
replacing the first network traffic routing protocol with the second network traffic routing protocol before the future period of time.

18. The non-transitory computer-readable storage medium as described in claim 17, wherein converted timeseries data that is three-dimensional is generated from the timeseries data and wherein the predicted processing unit utilization is generated based on the converted timeseries data.

19. The non-transitory computer-readable storage medium as described in claim 17, wherein the predicted processing unit utilization is greater than an over-utilized threshold and the second network traffic routing protocol decreases an amount of network traffic routed to the computing cluster before the future period of time.

20. The non-transitory computer-readable storage medium as described in claim 17, wherein the predicted processing unit utilization is less than an under-utilized threshold and the second network traffic routing protocol increases an amount of network traffic routed to the computing cluster before the future period of time.
